(19) United States
(12) Patent Application Publication
(10) Pub. No.: US 2006/0093132 A1
(43) Pub. Date: May 4, 2006

(54) Wireless earpiece for cell phone

(75) Inventors: Oliver Desormiere, Meudon (FR); Nicolas Gontard, Hong Hong (HK); Damien Francois, Shenzhen (CN); Guillaume Ponticelli, Hong Kong (HK)

Correspondence Address: CASELLA & HESPOS, 274 MADISON AVENUE, NEW YORK, NY, 10016, US

(73) Assignee: INNOVI TECHNOLOGIES LIMITED, Hong Kong (HK)

(21) Appl. No.: 11/214,160

(22) Filed: Aug. 29, 2005

(30) Foreign Application Priority Data
Aug. 30, 2004 (FR) 04 09184

(51) Int. Cl. H04M 1/00; H04M 9/00

(52) U.S. Cl. 379/431

(57) ABSTRACT

The wireless earpiece comprises two bodies (1, 2) articulated one about the other, one of which bears a speaker for fitting into the ear of the user. The other body (2) wraps around the outer part of this ear to hold the earpiece in the use position. A metal return spring (7) is wound around the hinge pin (5) of the two bodies (1, 2) to return the latter toward one another, when at rest, while clamping the user's ear which allows the earpiece to be held in position. The earpiece allows quick fitting and effective hold in this position.

### BACKGROUND OF THE INVENTION

1. Field of the Invention

The present invention relates to so-called “handsfree” systems for cell phones and, more particularly, to a system of this type in the form of an earpiece for discreet fixing to the ear of the user, allowing the user to hold a telephone conversation while retaining free use of both hands, for example for driving a car, practicing sport (e.g. cycling or golf), etc.

2. Description of the Related Art

There exists a known earpiece of the type mentioned above, available under the trade name “Ericsson”, which is composed of two bodies articulated one about the other, the one rigid body having a speaker at one end, for fitting into the ear of the user, and a microphone at the opposite end, and the other body taking the form of a flexible wire (or rubber hook) designed to pass around a large part of the perimeter of the ear at the back, such as to wrap the ear somewhat in the style of the end of the arm of a pair of spectacles to hold the earpiece in place. This earpiece system has the advantage that the user can easily put it on with one hand, yet has the disadvantage of not allowing the user to make sudden movements or to run without the risk of losing it. In addition, if the user wears spectacles, these may prevent the flexible wire (or rubber hook), which holds the earpiece in place, from earpiece in place, from fitting properly around the ear.

There also exists another known type of earpiece under the trade name “JABRA BT 200”, which is fixed behind the ear and is thus held very firmly in place. However, this earpiece is difficult to put on, especially with one hand. In addition it is found to be uncomfortable after a certain number of hours use and cannot therefore be worn the whole day long. Furthermore it is not at all comfortable for spectacle-wearers to wear.

There is also another type of earpiece which is held in place by a clamping system, but this is an ultra lightweight wired earpiece containing only speaker and microphone without battery or transmission electronics. With this device the speaker is fitted in the ear and a plastic component is folded back behind the ear as a clamp. However, the clamp is held on by a friction effect which becomes painful after a certain length of time.

The purpose of the present invention is to overcome the abovementioned disadvantages of known wireless earpieces and it therefore provides an earpiece which combines light weight, pleasing appearance and outstanding technical quality with quick and easy fitting and effective hold whether on the left or right ear of the user.

### SUMMARY OF THE INVENTION

To this end the wireless earpiece for cell phones according to the present invention is of the type comprising two bodies articulated one about the other and each having electronic components, one of which bears a speaker for fitting into the ear of the user when in the use position and the other wrapping around the outer lower part of the same ear to hold the earpiece in the use position. The earpiece features a spring linked to the hinge between said bodies for returning for returning the latter toward one another, when at rest, clamping the ear which serves to hold the earpiece in its use position while providing long-term comfort.

According to a preferred embodiment of the invention, said return spring in the clamping position of the two bodies constituting the earpiece is a metal spring wound around the hinge pin of the two bodies, each end of which acts together with one of the two bodies.

Advantageously, the hinge between the two bodies constituting the earpiece comprises a flexible piece which is fixed to one end of one of said bodies and accommodates, in an opening at its opposite end, the hinge pin borne by the other body and around which the return spring is wound.

Although known, commercially available earpieces are normally designed with the facility to be fixed to either ear, they do generally require cumbersome adjustment involving the removal of one piece, which is generally plastic (with the resulting risk of wear and fracture), turning it around, and then reassembling it.

According to an additional feature of the invention, changing the side of the earpiece can be executed by simply turning one of the earpiece pieces bearing the speaker through at least 180°.

To this end, the body bearing the speaker terminates in a projecting longitudinal shaft, this shaft being engaged such it rotates in an internal cavity of a support bearing the speaker.

Advantageously, said rotational shaft of the speaker comprises a part of oblong cross section which acts together with parallel wall elements arranged on either side of the shaft, such that when the speaker is fitted in the right or left ear of the user, the flat sides of the oblong part of the shaft engage on the wall elements, which holds the speaker in place, whereas when the speaker rotates from one of its from one of its use positions to the other, the circular parts of the oblong part of the shaft are in contact with the wall elements, causing by friction a resistance effect upon rotation.

According to an additional feature, the rotational shaft concentrically bears a ring portion such that upon rotation of the speaker support in one direction or in the opposite direction to move from one use position to the other, one or other end of this ring portion abuts against a lug borne by the support of the speaker restricting the amplitude of rotation. The length of said ring portion may be advantageously calculated to allow the speaker to rotate a few degrees beyond its normal fitting position in the right or left ear of the user, allowing perfect adjustment on each of the two ears.

In order to facilitate understanding of the invention a preferred embodiment will be described below, by way of example and without implying any limitation, with reference to the appended schematic drawing in which:

### BRIEF DESCRIPTION OF THE DRAWINGS

FIG. 1 is a front view of a wireless earpiece according to the invention, in a position allowing fitting onto the right ear of the user.

FIG. 2 is a detail view, on a larger scale, showing in particular the hinge mechanism of the two elements constituting the wireless earpiece of FIG. 1.

FIG. 3 is a view corresponding to FIG. 2, showing in particular the inside of the hinge housing.

FIG. 4 is a perspective view showing the inside of the support piece of the earpiece speaker.

FIG. 5 is a perspective view showing the inside of the piece which closes off the support piece of FIG. 4.

FIG. 6 is a partial front view showing the rotational shaft belonging to one of the earpiece elements according to the invention which acts together with the support piece of FIG. 4.

FIG. 7 is an end view of the shaft of FIG. 6.

FIG. 8 is a perspective view showing how the support piece of the speaker acts together with its rotational shaft, in the position of the earpiece for fitting to the left ear of a user.

FIG. 9 is a perspective view corresponding to FIG. 8, after the support piece of the speaker has been rotated through 90° in the counter-clockwise direction.

### DETAILED DESCRIPTION OF THE PREFERRED EMBODIMENTS

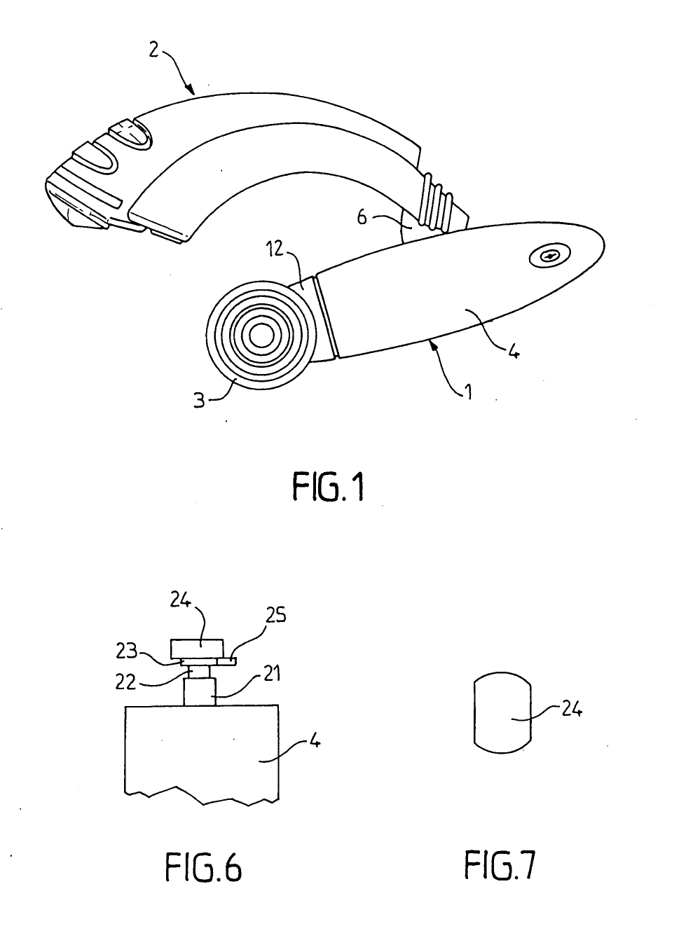

Referring to FIG. 1, a wireless earpiece according to the invention has been illustrated which can be used in conjunction with a cell phone. This earpiece is composed of two elements 1, 2 linked by a hinge.

The element 1, made of plastic, comprises at one end a speaker 3 of circular shape, for insertion into one of the ears of the user. As will be explained below, the speaker 3 can pivot through more than 180° to allow the earpiece to be fitted on either the right or left ear of a user.

The body of the element 1 is continued by a housing 4, and ends at its opposite end in a microphone. It also comprises a power supply battery.

The element 2, also made of plastic, has an arcuate shape which allows it to rest snugly against the ear of the user. This element 2 contains electronic circuitry (not shown on the drawing).

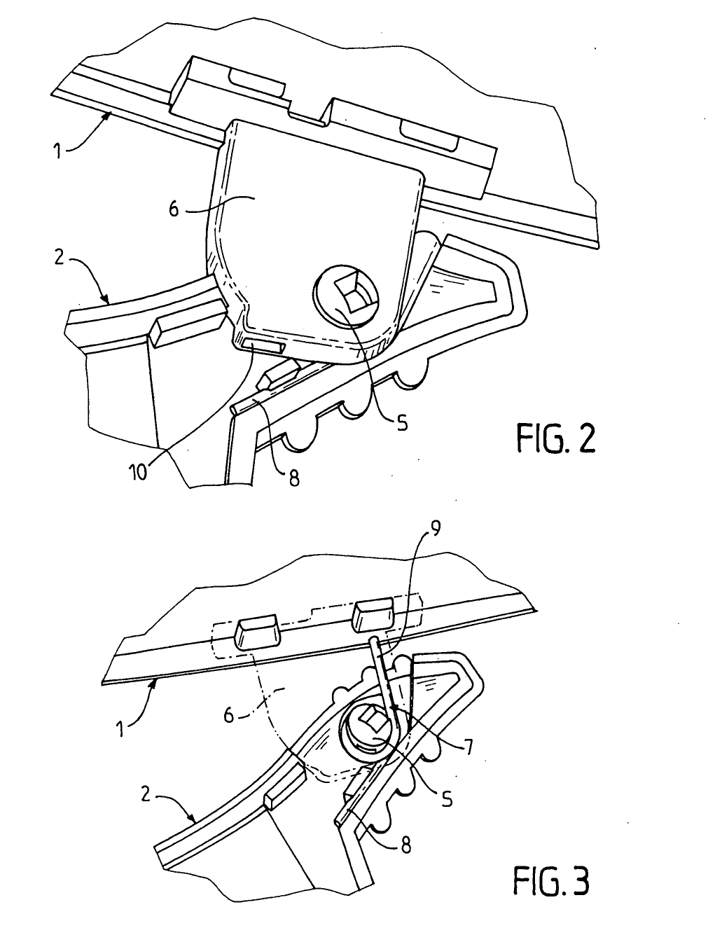

At one end, the element 2 is connected by a hinge to the element 1, at a point on the latter close to the end opposite the speaker 3. To this end, as can be seen in FIG. 2, the element 2 internally comprises a transverse pin 5 which is engaged in a circular opening in a connecting piece 6 made of a flexible material such as rubber, forming the hinge housing, the opening being located at one end of which the other end is fixed in the body of the element 1.

As can be seen more clearly in FIG. 3, which shows the inside of the connecting piece 6, a metal spring 7 is wound around the pin 5 with one of its arms 8 in abutment in the body of the element 2 and its other arm 9 in abutment in the body of the element 1. Thus, at rest, the spring 7 presses the element 2 against the element 1 clamping the ear of the user, while the elements 1 and 2 can be pushed apart, against the action of the spring 7, to fit the earpiece onto the ear of the user, or to remove it.

It will be seen that there is an opening 10 (FIG. 2) in the connecting piece 6 through which wires or a flexible printed circuit can pass from one to the other of the elements 1 and 2.

The part forming speaker 3 is designed to rotate about a shaft 21 which projects longitudinally at one end of the housing 4 (FIG. 6). To this end, the end of the shaft 21 is intended to engage in an internal housing of a piece 12 which acts as a support for the speaker 3. The support piece 12 is divided, along a median longitudinal plane, into two parts 13, 13′, one of which bears the speaker 3.

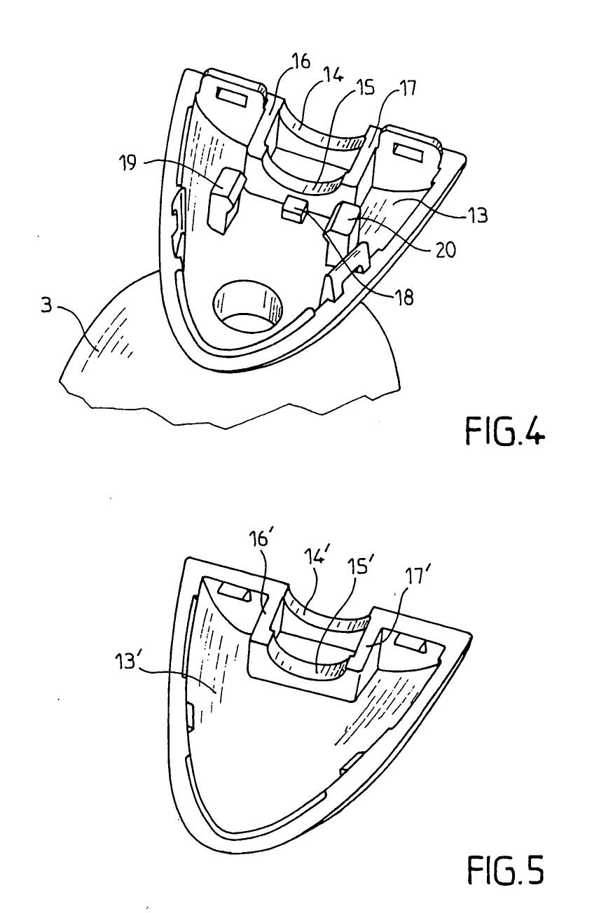

As can be seen in FIG. 4, the part 13 of the piece 12, which bears the speaker 3, centrally comprises at its lower part two parallel, arcuate, transverse holding walls 14, 15, the outer wall 14 having a radius of curvature greater than that of the wall 15. Two parallel longitudinal walls 16, 17 link the corresponding ends of corresponding ends of the walls 14, 15. In front of the wall 15, at its center, is a lug 18, forming a stop, the function of which will be explained below.

Two parallel longitudinal walls 19, 20 are arranged in front of the lug 18, the spacing between said walls being greater than that between the walls 16, 17.

As shown in FIG. 6, the housing 4 of the element 1 ends, at its end opposite to the hinge with the element 2, in a shaft 21, of which the cylindrical lower part is continued by a cylindrical part 22 of smaller diameter, then by a cylindrical part 23 of the same diameter as the part 21 and by a final part 24 which is slightly oblong (see FIG. 7). Over at least one third of its periphery, the cylindrical part 23 is integral with a ring part 25, the function of which will be explained below.

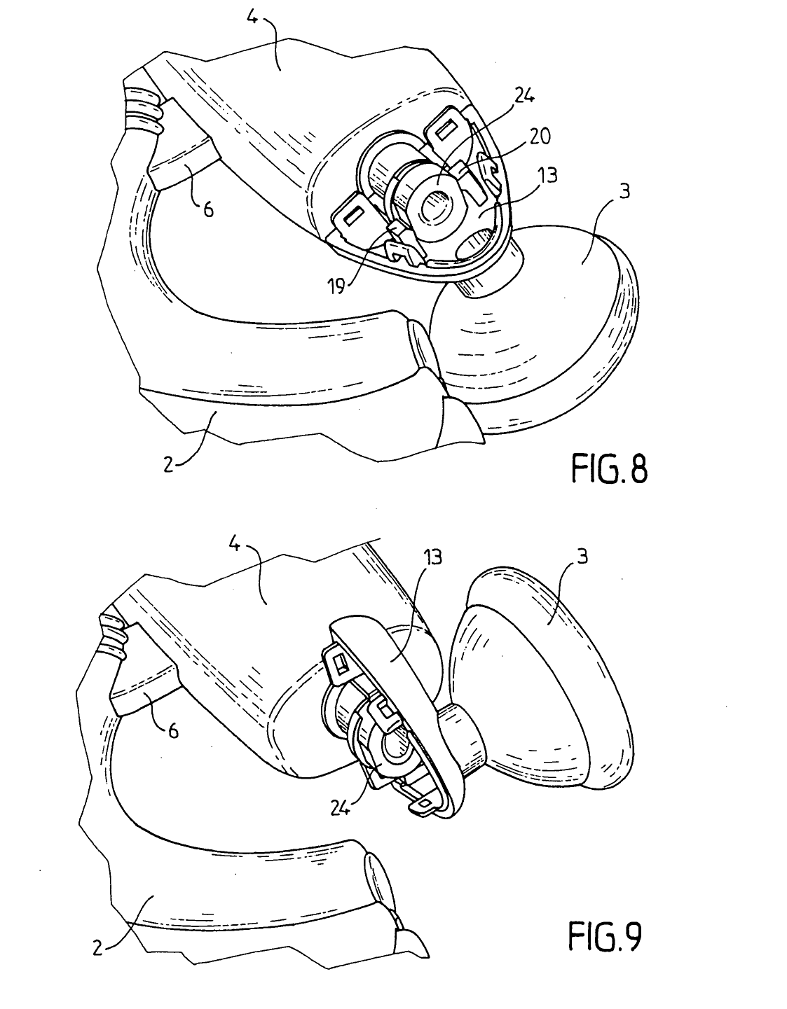

As has been shown in FIGS. 8 and 9, the pivoting mounting of the support piece 13 of the speaker 3 is produced by engaging the rotational shaft 21 in the housings of the support 13, such that:
the lower cylindrical part of the shaft 21 bears against the arcuate wall 14, being engaged between the walls 16 and 17,
the cylindrical part 22 of the shaft bears against the arcuate wall 15,
the cylindrical part 23 bears on the lug 18, such that upon rotation of this part 23 about its longitudinal shaft, one or other of the ends of the ring part 25 abuts against the lug 18, restricting the angle of this rotation, and
the oblong outer wall 24 of the shaft engages between the walls 19, 20.

Once the shaft 21 is in place in the housing of the piece 13, the latter is closed by applying and clipping piece 13′ which forms a cover, said piece 13′ internally having (FIG. 5) arcuate walls 14′, 15′ and rectilinear walls 16′, 17′ which act together with the corresponding walls 14, 15, 16, 17 of the support piece 13 to enclose the shaft 21 while leaving it free to rotate.

The operation of the device will immediately be understood from the foregoing description.

In the position of the support piece 13 of the speaker 3 shown in FIG. 8, the device is in a position to be fitted to the left ear of a user, the two flat sides of the oblong part 24 of the shaft 21 serving a holding function by means of the walls 19, 20, and the left-hand end of the ring part 25 being close to the lug 18.

As the support piece 13 starts to be rotated about the shaft 21 in the counter-clockwise direction with regard to FIG. 8, the two walls 19, 20 then come into contact with the round parts of the oblong part 24 (see FIG. 9), which then creates a resistance effect by friction upon handling.

As rotation continues and after the support has been rotated through 180° from the position of FIG. 8, a click is felt on account of the fact that the walls 19, 20 are coming into contact with the round parts of the oblong part 24 of the shaft 21, locking the support piece 13 in the position of the speaker 3, allowing the device to be fitted to the right ear of the user. In this position (not shown), the support piece 13 can still rotate a few degrees until abutting by means of the ring part 25 against the lug 18 which allows for the device to be perfectly adjusted on the ear, the body of the element 1 then being tight against the cheek of the user. Without this adjustment facility, the alignment of the speaker 3 on the ear would result in the element 1 being a little too far from the cheek.

In the same way, when the support piece 13 is in its position of cooperation with the left ear of the user (FIG. 8), said support piece 13 can be rotated through a few degrees in the clockwise direction to allow for perfect adjustment on that ear, until the ring part 25 abuts against the lug 18.

It will be understood that the description above has been given purely by way of example, without implying any limitation, and that design additions or modifications may be made without departing from the scope of the invention determined by the appended claims.

What is claimed is:

1. A wireless earpiece for cell phones, comprising two bodies (1, 2) articulated one about the other, one of which bears a speaker (3) for fitting into the ear of the user when in the use position and the other (2) wrapping around the outer lower part of the same ear to hold the earpiece in the use position, wherein a spring (7) is linked to the hinge between said bodies (1, 2) for returning the latter toward one another, when at rest, clamping the ear of the user which serves to hold the earpiece in its use position.

2. The wireless earpiece for cell phones of claim 1, wherein said return spring (7) is a metal spring wound around the hinge pin (5) of the two bodies (1, 2), each end (8, 9) of which acts together with one of the two bodies (1, 2).

3. The wireless earpiece for cell phones of claim 2, wherein the hinge between the two bodies (1, 2) comprises a flexible piece (6) such as rubber fixed to one end of one of said bodies (1) and accommodating in an opening at its opposite end the hinge pin (5) borne by the other body (2), said return spring (7) being wound around this hinge pin (5).

4. The wireless earpiece for cell phones of claim 3, wherein said hinge piece (6) has a hollow part (10) through which electrical wires or a flexible printed circuit can pass from one body of said bodies to the other.

5. The wireless earpiece for cell phones of claim 4, wherein the speaker (3) borne by one of said bodies (1) can pivot around a longitudinal shaft (21) through at least 180°, to provide the facility to fix the earpiece to either the left or the right ear of the user.

6. The wireless earpiece for cell phones of claim 5, wherein the body (1) bearing the speaker (3) terminates in a projecting longitudinal shaft (21), said shaft (21) being engaged such it rotates in an internal cavity (14, 15, 16, 17, 14′, 15′, 16′, 17′) of a support piece (13, 13′) bearing the speaker (3).

7. The wireless earpiece for cell phones of claim 6, wherein said rotational shaft (21) of the speaker (3) comprises a part (24) of oblong cross section which acts together with parallel wall elements (19, 20) arranged on either side of the shaft (21), such that when the speaker (3) is fitted in the right or left ear of the user, the flat sides of the oblong part (24) of the shaft (21) engage on the wall elements (19, 20), which holds the speaker (3) in place, whereas when the speaker (3) rotates from one of its use positions to the other, the circular parts of the oblong part (24) of the shaft (21) are in contact with the wall elements (19, 20), causing by friction a resistance effect upon rotation.

8. The wireless earpiece for cell phones of claim 7, which comprises a ring portion (25) concentrically borne by the rotational shaft (21), one or other end of this ring portion (25) abutting, upon rotation of the support piece (13, 13′) of the speaker (3) in one direction or in the opposite direction to move from one use position to the other, against a lug (18) borne by the support piece (13,13′) of the speaker (3) restricting the amplitude of rotation.

9. The wireless earpiece for cell phones of claim 6, which comprises a ring portion (25) concentrically borne by the rotational shaft (21), one or other end of this ring portion (25) abutting, upon rotation of the support piece (13, 13′) of the speaker (3) in one direction or in the opposite direction to move from one use position to the other, against a lug (18) borne by the support piece (13,13′) of the speaker (3) restricting the amplitude of rotation.

10. The wireless earpiece for cell phones of claim 1, wherein the speaker (3) borne by one of said bodies (1) can pivot around a longitudinal shaft (21) through at least 180°, to provide the facility to fix the earpiece to either the left or the right ear of the user.

11. The wireless earpiece for cell phones of claim 10, wherein the body (1) bearing the speaker (3) terminates in a projecting longitudinal shaft (21), said shaft (21) being engaged such it rotates in an internal cavity (14, 15, 16, 17, 14′, 15′, 16′, 17′) of a support piece (13,13′) bearing the speaker (3).

12. The wireless earpiece for cell phones of claim 11, wherein said rotational shaft (21) of the speaker (3) comprises a part (24) of oblong cross section which acts together with parallel wall elements (19, 20) arranged on either side of the shaft (21), such that when the speaker (3) is fitted in the right or left ear of the user, the flat sides of the oblong part (24) of the shaft (21) engage on the wall elements (19, 20), which holds the speaker (3) in place, whereas when the speaker (3) rotates from one of its use positions to the other, the circular parts of the oblong part (24) of the shaft (21) are in contact with the wall elements (19, 20), causing by friction a resistance effect upon rotation.

13. The wireless earpiece for cell phones of claim 12, which comprises a ring portion (25) concentrically borne by the rotational shaft (21), one or other end of this ring portion (25) abutting, upon rotation of the support piece (13, 13′) of the speaker (3) in one direction or in the opposite direction to move from one use position to the other, against a lug (18) borne by the support piece (13, 13′) of the speaker (3) restricting the amplitude of rotation.

14. The wireless earpiece for cell phones of claim 11, which comprises a ring portion (25) concentrically borne by the rotational shaft (21), one or other end of this ring portion (25) abutting, upon rotation of the support piece (13, 13′) of the speaker (3) in one direction or in the opposite direction to move from one use position to the other, against a lug (18) borne by the support piece (13, 13′) of the speaker (3) restricting the amplitude of rotation.
